(19) United States
(12) Patent Application Publication
(10) Pub. No.: US 2005/0185522 A1
(43) Pub. Date: Aug. 25, 2005

(54) Signal processing method and apparatus for high speed optical storage device

(75) Inventors: Tse-Hsiang Hsu, Hsinchu (TW); Chia-Hua Chou, Hsintien City (TW)

Correspondence Address: BACON & THOMAS, PLLC, 625 SLATERS LANE, FOURTH FLOOR, ALEXANDRIA, VA, 22314, US

(73) Assignee: Mediatek Incorporation, Hsinchu (TW)

(21) Appl. No.: 11/011,182

(22) Filed: Dec. 15, 2004

Related U.S. Application Data
(60) Provisional application No. 60/521,083, filed on Feb. 19, 2004.

(51) Int. Cl. G11B 7/00

(52) U.S. Cl. 369/30.1; 369/30.45

(57) ABSTRACT

A method and an apparatus for a high speed optical storage device performs a clamping process on light detection signals or their arithmetic results in an optical pickup unit, before being transmitted to an optical disk driver (ODD) controller via a flexible cable. Therefore, the highest level of each of these clamped signals is not higher than a clamping threshold. By this way, the valid portion of the clamped signal during the land-forming period for follow-up signal process is increased so that the stability of an optical disk servo control is effectively improved, especially for the high-speed optical disk system.

### BACKGROUND

The present invention relates to a signal processing method and apparatus for a high speed optical storage device, and particularly relates to a method and apparatus which maintain superior light detection signals even when the optical storage device operates at a high-speed and read/write periods are shortened.

With reference to FIG. 1, a conventional optical disk drive (ODD) architecture is composed of an optical pickup unit (12), an ODD controller (14), and a flexible cable (16) coupled between the optical pickup unit (12) and the ODD controller (14). The optical pickup unit (12) comprises a laser diode driver (LDD) (120), a laser diode (LD) (122), a splitter (124), an objective lens (126) and a photo detector (128). The ODD controller (14) includes a servo controller (142) and an analog front-end unit (140) in which a sample/hold circuit (144) is used.

Based on the control of the LDD driver (120), the LD (122) can generate a laser beam that irradiates on an optical disk (10) through the splitter (124) and the objective lens (126). The reflected laser beam from the optical disk (10) is then received by the photo detector (128) and converted into plural light detection signals. These light detection signals are subsequently transmit to the ODD controller (14) through the flexible cable (16). The analog front-end unit (140) in association with sample/hold circuit (144) retrieves desired information from the light detection signals to perform relevant signal processing such as wobble signal recovery. According to the signal processing result, control signals required for optical disk operations are produced and provided to the servo controller (142). As an example, physical addresses of the optical disk (10) can be derived based on the recovered wobble signal.

When inspecting the optical disk (10), plural wobble tracks with grooves are formed on its surface. It is noted that the tracks are not arranged in the form of concentric circles but like curved wave pattern. With reference to FIG. 2, the plural curves (27) on the optical disk (10) stand for the wobble tracks. The photo detector (128) is composed of a main light receiving element (20) and two auxiliary light receiving elements (22)(24). The main light receiving element (20) includes four light detection areas A, B, C and D, where two areas A and D are situated by one side of a virtual track (28) and the other areas B and C are situated by the other side of the virtual track (28). Similarly, the first auxiliary light receiving element (22) with light detection areas E and F is located by one side of the virtual track (28) while the second auxiliary light receiving element (24) with light detection areas G and H is at the other side. Each of the aforementioned light detection areas A-F will produce and transmit an independent signal to a gain buffer (26) thus generating corresponding light detection signals S_{A}, S_{B}, S_{C}, S_{D}, S_{E}, S_{F}, S_{G} and S_{H}. Based on the eight light detection signals, various kinds of signals such as a push pull signal, a tracking error signal, a focusing error signal and a radio frequency signal all can be easily calculated.

As shown in FIG. 3, when the optical disk drive performs a high-speed recording operation, since the power of the laser beam from the laser diode (122) is varied with data to be written, the output light detection signals of the photo detector (128) all accordingly have the similar variation. After transmitting the light detection signals to the ODD controller (14) via the flexible cable (16), sample and hold processes are then performed on these light detection signals. However, the data transmission quality of the flexible cable (16) is not ideal especially for high speed transmission. Due to the narrow transmission bandwidth and low slew rate, an undesired long settling period, which occurs at the same time that the light detection signals are changing, required for stabilizing the light detection signals may exceed toleration. For example, during the wobble signal recovery process, the push pull signal S_{PP} is the essential parameter and can be calculated in accordance with its definition S_{PP}=(S_{A}+S_{D})−(S_{B}+S_{C}). Once the push pull signal S_{PP} has been derived, the wobble signal can then be recovered thus obtaining the physical address of the optical disk (10). The push pull signal S_{PP} can be derived by feasible schemes explained as follows.
1. The light detection signals S_{A}, S_{B}, S_{C} and S_{D} are firstly transmitted to the ODD controller (14) via the flexible cable (16) from the optical pickup unit (12), wherein the light detection signals received by the ODD controller (14) are respectively denoted with S*_{A}, S*_{B}, S*_{C} and S*_{D} hereinafter for distinction. Upon the received light detection signals, the ODD controller (14) performs the operation S_{PP}=(S*_{A}+S*_{D})−(S*_{B}+S*_{C}) to derive the push pull signal S_{PP}.
2. The light detection signals S_{A} and S_{D} are added together to derive a composite signal S_{AD}(S_{AD}=S_{A}+S_{D}) by the optical pickup unit (12). The addition operation is also performed on the other two signals S_{B} and S_{C} to generate another composite signal S_{BC}(S_{BC}=S_{B}+S_{C}). The two composite signals S_{AD} and S_{BC} are subsequently transmitted to the ODD controller (14) via the flexible cable (16). Upon receiving the composite signals, the ODD controller (14) directly performs an operation S*_{AD}−S*_{BC} to derive the push pull signal S_{PP}.

With reference to FIG. 3, the light detection signal S_{A} output from the optical pickup unit (12) and the light detection signal S*_{A} received by the ODD controller (16) are respectively illustrated by a broken line and a solid line. Since other light detection signals have the similar waveform as the signal S_{A}, they are accordingly omitted from the drawing. During the pit-forming period, the output laser beam has the stronger power so that the light detection signal has a higher level than that in the land-forming period.

At the time that the pit-forming period is altered to the land-forming period, although the light detection signal S_{A} in the optical pickup unit (12) rapidly changes from the high level to the low level, the received light detection signal S*_{A} does not. The received light detection signal S*_{A} requires a settling period (32) after which the signal S*_{A} is gradually stabilized. In other words, the end portion of the light detection signal during the pit-forming period has interfered with the light detection signal in the land-forming period. The settling period (32) can be deemed as the interference time during which the light detection signal is not applicable. Thus, the light detection signal existing during the rest period (34) of the land-forming period is able to be sampled. The interference problem is mainly caused from the flexible cable (16). If the intrinsic impedance of the flexible cable (16) or its material are inferior, the settling period (32) will become longer so that the remaining available period (34) is consequently occupied.

If the data recording process remains at low speed, the settling time (32) does not occupy too much land-forming period. Such an interference problem is still tolerable. However, with the increasing of the date recording speed, i.e. both the pit-forming period and the land-forming period are shortened, the extent that the settling time (32) exists in the whole land-forming period will significantly increase. The worst situation is the settling time (32) occupies almost all the land-forming period and there is no available period (34). That is to say, no stabilized light detection signal is able to be sampled, and the optical disk driver may have possible abnormal operation.

Therefore, the invention provides a novel method and apparatus for high speed optical storage device to mitigate or obviate the aforementioned problem.

### SUMMARY OF THE INVENTION

The main objective of the present invention is to provide a signal processing method and an apparatus for high-speed data recording of an optical disk drive, wherein the method and the apparatus are able to maintain high quality of light detection signals even when the optical disk drive performs high-speed data recording and its read/write periods are significantly shortened.

To accomplished the objective, the method performs a clamping process on the light detection signals or their composite signals before transmitting to an optical disk drive controller via a flexible cable, whereby the highest level of each of these clamped signals keeps below a clamping threshold. By this way, the valid portion of the clamped signal, during the land-forming period, for a follow-up signal process is increased.

Furthermore, the apparatus in accordance with the present invention comprises:
an optical pickup unit having:
   a laser light source generating a laser beam to irradiate a track formed on an optical disk;
   a photo detector that receives a reflected light from the optical disk and converts the reflected light signal into plural light detection signals; and
   a clamping unit comprising at least one clamper that clamps at least one electrical signal to derive a clamped signal, whereby the clamped signal keeps below a threshold value; wherein the at least one electrical signal is chosen from either the light detection signals or their arithmetic composite signals;
an optical disk drive (ODD) controller provided to control the optical pickup unit; and
at least one flexible cable coupled between the optical disk drive controller and the optical pickup unit for transmitting signals therebetween;
wherein after clamping the at least one electrical signal, the clamped electrical signal is then transmitted to the ODD controller via the flexible cable, hence the quality of the received signals by the ODD controller is enhanced.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a conventional optical disk driver;

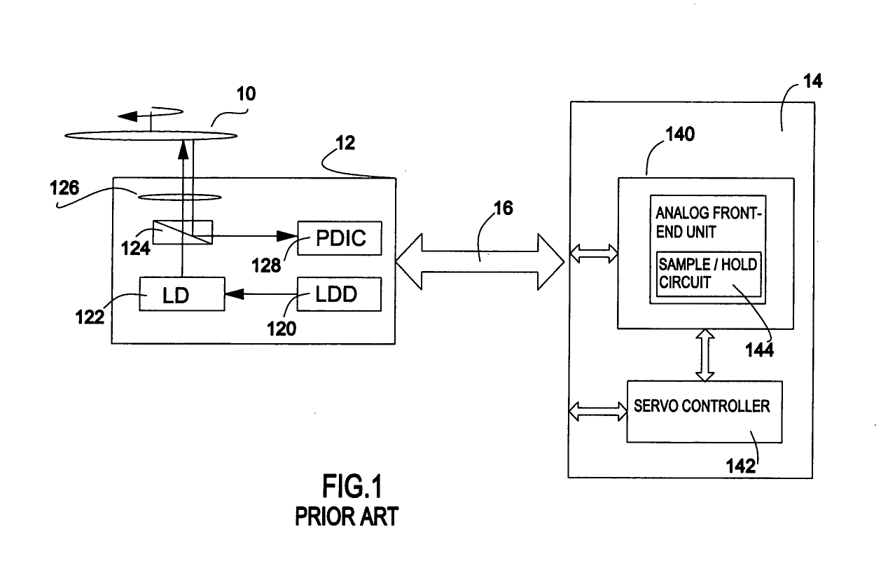

FIG. 2 is an exemplary architecture schematic view of a conventional photo detector;

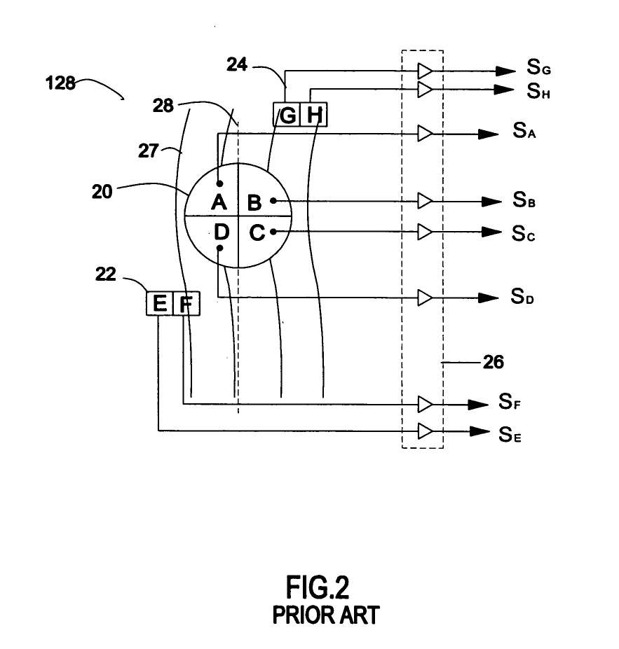

FIG. 3 is an exemplary waveform view showing a light detection signal S_{A} output from an optical pickup unit and a transmitted light detection signal S*_{A} received by an optical disk drive controller in accordance with the conventional data recording process;

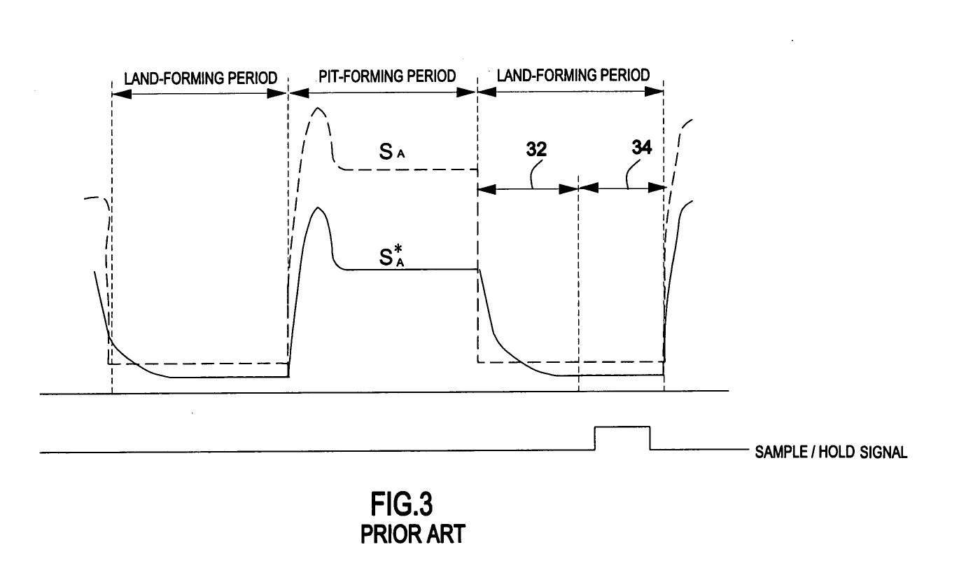

FIG. 4 is a block diagram of an optical disk drive according to a first embodiment of the present invention;

FIG. 5 is an exemplary waveform view showing a transmitted light detection signal S*_{A} and a clamped light detection signal X*_{A} of FIG. 4;

FIG. 6 is a block diagram of an optical disk drive according to a second embodiment of the present invention;

FIG. 7 is an exemplary waveform view showing a transmitted composite signal S*_{AD} and a clamped composite detection signal X*_{AD} of FIG. 6;

FIG. 8 is a block diagram of an optical disk drive according to a third embodiment of the present invention;

FIG. 9 is a block diagram of an optical disk drive according to a fourth embodiment of the present invention;

FIG. 10 is a block diagram of an optical disk drive according to a fifth embodiment of the present invention; and

FIG. 11 is an exemplary waveform view showing a clamped composite signal X*_{AD} and a clamped difference signal X*_{PP} of FIG. 10.

### DETAILED DESCRIPTION OF THE PREFERRED EMBODIMENT

In the present invention, light detection signals or their composite signals, before being transmitted to an ODD controller via a flexible cable, are firstly clamped below a threshold value. After the ODD controller receives these clamped light detection signals or composite signals, the interference problem existing in land-forming periods will thus be effectively mitigated. Therefore, available portions of the clamped light detection signals in the land-forming periods accordingly increase to supply more useful information and control signals with superior quality for an optical disk driver. The control signals may be a push pull signal, a tracking error signal, a focusing error signal, a radio frequency signal etc. In the embodiments discussed hereinafter, the push pull signal is used as an example and discussed in detail. However, the present invention is also suitable to acquire superior other control signals.

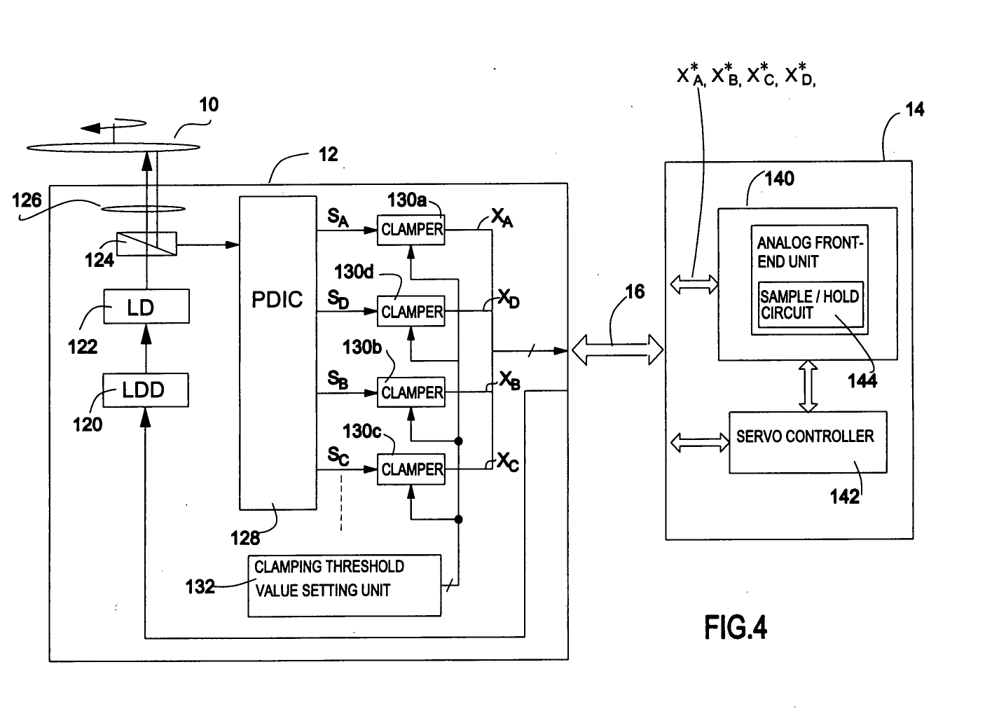

With reference to FIG. 4, an optical disk drive in accordance with the first embodiment of the present invention comprises an optical pickup unit (12) and an optical disk driver (ODD) controller (14) between which a flexible cable (16) is connected. The optical pickup unit (12) mainly has a laser diode driver (120), a laser diode (122), a splitter (124), an objective lens (126) and a photo detector (128). The ODD controller (14) includes a servo controller (142) and an analog front-end unit (140) in which a sample/hold circuit (144) is utilized.

When laser beam is reflected from an optical disk (10), the photo detector (128) receives and converts it into plural light detection signals respectively denoted by S_{A}, S_{B}, S_{C}, S_{D}, S_{E}, S_{F}, S_{G} and S_{H}. In order to implement the above mentioned clamping process, a clamping unit is embodied in the optical pickup unit (12). The clamping unit comprises multiple clampers (130a-130d) that respectively limit a corresponding light detection signal (S_{A}, S_{B}, S_{C} and S_{D}) below a threshold value, wherein the threshold value is determined by a clamping threshold value setting unit (132). To distinguish the clamped signals from the original light detection signals, the clamped light detection signals are respectively indicated by X_{A}, X_{B}, X_{C} and X_{D}. After the clamped light detection signals are transmitted to the ODD controller (14) through the flexible cable (16), the transmitted clamped light detection signals are further designated with X*_{A}, X*_{B}, X*_{C} and X*_{D}. An essential point to be emphasized is that ahead of transmitting the light detection signals, the light detection signals have been clamped to limit their highest level thereby preventing an interference result from the flexible cable (16).

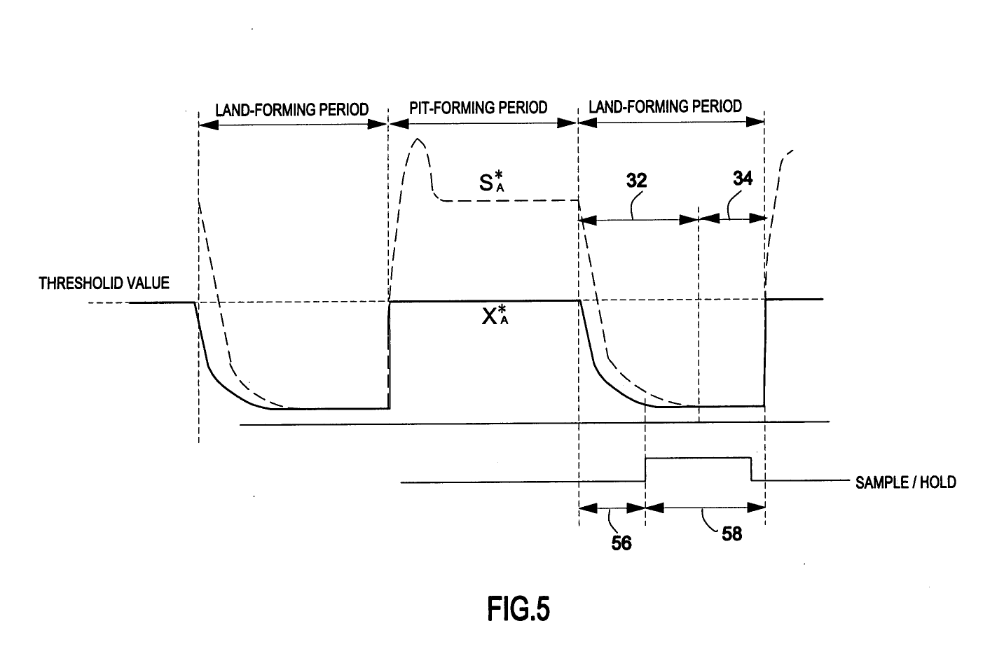

With reference to FIG. 5, in a usual situation, the level of the light detection signal S_{A} during the land-forming period is lower than the threshold value and is unaffected by the clamping processes. After the light detection signal S_{A} has been clamped, a portion of the light detection signal exceeding the threshold value will be limited. In FIG. 5, the clamped light detection signal X*_{A} received by the ODD controller (14) according to the present invention is illustrated by a solid line, and a non-clamped light detection signal S*_{A} of the conventional technique is depicted by a broken line. In comparison with the signal S*_{A}, the settling time (56) transition from the high level to the low level of the clamped signal X*_{A} is obviously shorter than that (32) of the signal S*_{A}. The clamped signal X*_{A} consequently has a longer available time (58) than that (34) of the signal S*_{A}. In other words, the clamped signal X*_{A} is able to supply more useful information to be sampled. FIG. 5 only illustrates one light detection signal S_{A} as an example since the other signals S_{B}-S_{D} and S_{E}-S_{H} all have the same effects.

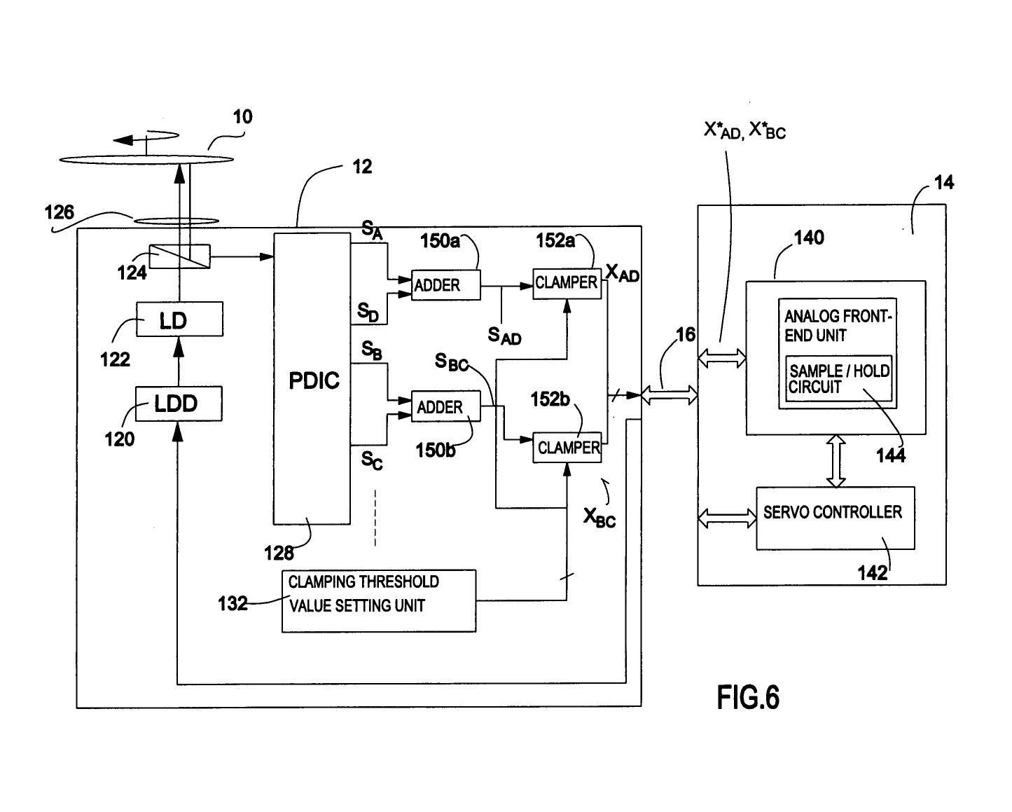

With reference to FIG. 6, the second embodiment of the present invention further comprises two adders (150a)(150b) in the optical pickup unit (12). The light detection signals S_{A} and S_{D} are firstly input to the first adder (150a) that performs an addition operation S_{A}+S_{D} to obtain a first composite signal S_{AD}. The second adder (150b) also performs an addition operation on the signals S_{B} and S_{C} to obtain a second composite signal S_{BC}. The two composite signals S_{AD} and S_{BC} are respectively furnished to two clampers (152a)(152b) to limit their levels. The clamped composite signals designated with X_{AD} an X_{BC} are further transmitted to the ODD controller (14) via the flexible cable (16).

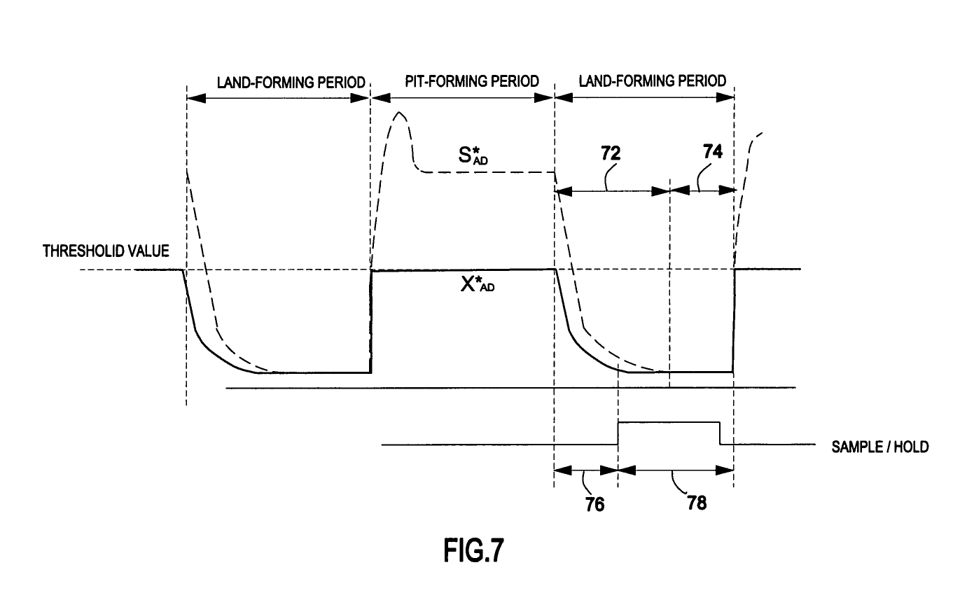

With reference to FIG. 7, only the composite signal S_{AD} is illustrated, since the other one, S_{BC}, is similar to signal S_{AD} and thus is omitted. The level of the composite signal S_{AD} during the land-forming period is usually lower than the threshold value so it is unaffected by the clamping processes. After the composite signal S_{AD} is clamped, the level of the clamped signal X_{AD} will not exceed the threshold value. In FIG. 7, the clamped signal X*_{AD} received by the ODD controller (14) according to the present invention is illustrated by a solid line, and a non-clamped signal S*_{AD} of the conventional technique is depicted by a broken line. In comparison with the signal S*_{AD}, the settling time (76) transition from the high level to the low level of the clamped signal X*_{AD} is shorter than that (72) of the signal S*_{AD}. The clamped signal X*_{AD} consequently has a longer available time (78) than that (74) of the signal S*_{AD}. In the embodiment, even when the light detection signals are not directly clamped but are pre-operated to produce composite signals, the clamped composite signals still contain more useful information thereby enhancing the signal quality.

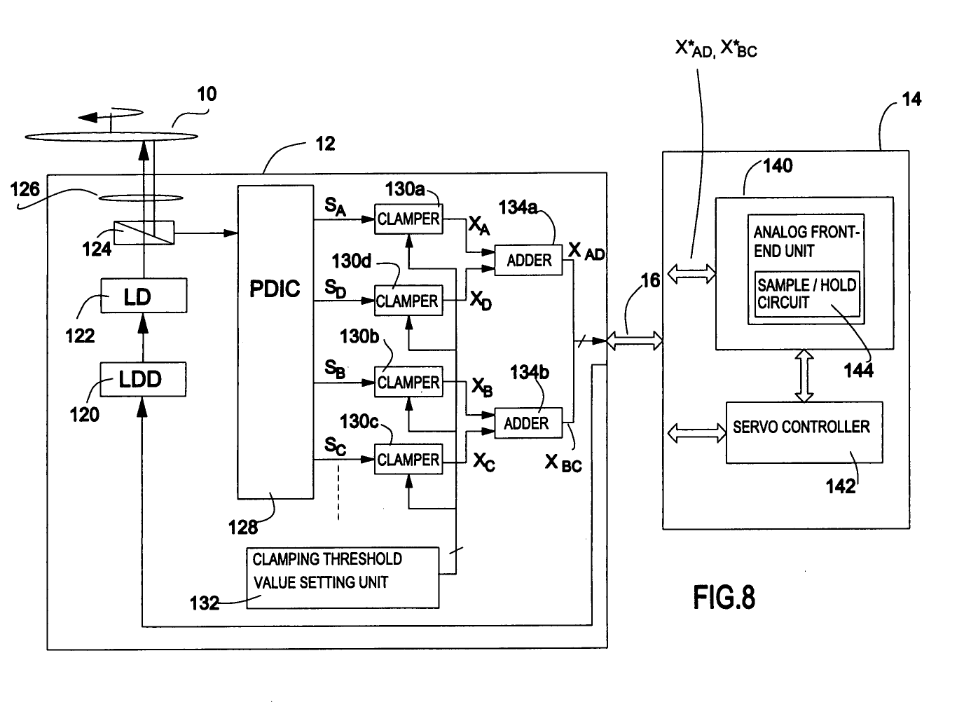

With reference to FIG. 8, in the third embodiment, each light detection signal S_{A} to S_{D} is firstly input a respective clamper (130a-130d) to limit its level. These clamped signals X_{A} to X_{D} are then transmitted to two adders (134a)(134b) in pairs to generate composite signals X_{AD} and X_{BC}. Both the clamped composite signals X_{AD} and X_{BC} are subsequently sent to the ODD controller (14) via the flexible cable (16) to further calculate a desired control signal such as the push-pull signal. In this architecture, although the clamping process is prior to the addition operation, the clamped signal finally received by the ODD controller (14) still has a quality superior to that of the prior art.

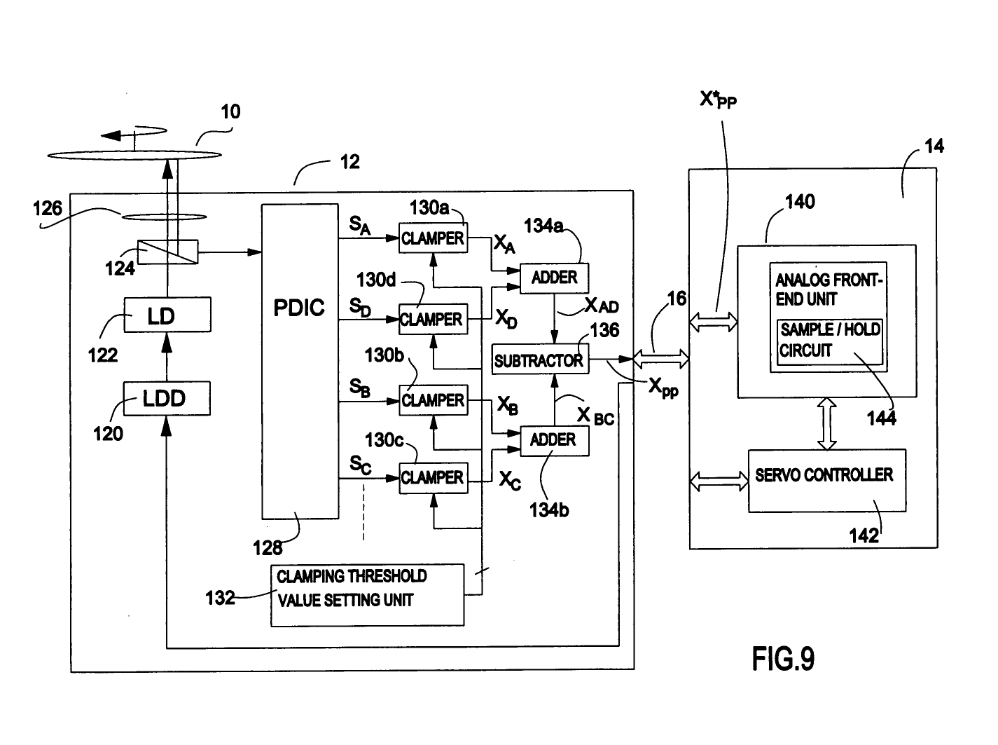

With reference to FIG. 9, the architecture of the fourth embodiment is substantially the same as that of FIG. 8, wherein a subtractor (136) is coupled between the two adders (134a)(134b) to perform a subtraction on the composite signals X_{AD} and X_{BC} thus deriving a difference signal X_{PP}=X_{AD}−X_{BC}. The difference signal X_{PP} is then sent to the ODD controller (14) via the flexible cable (16).

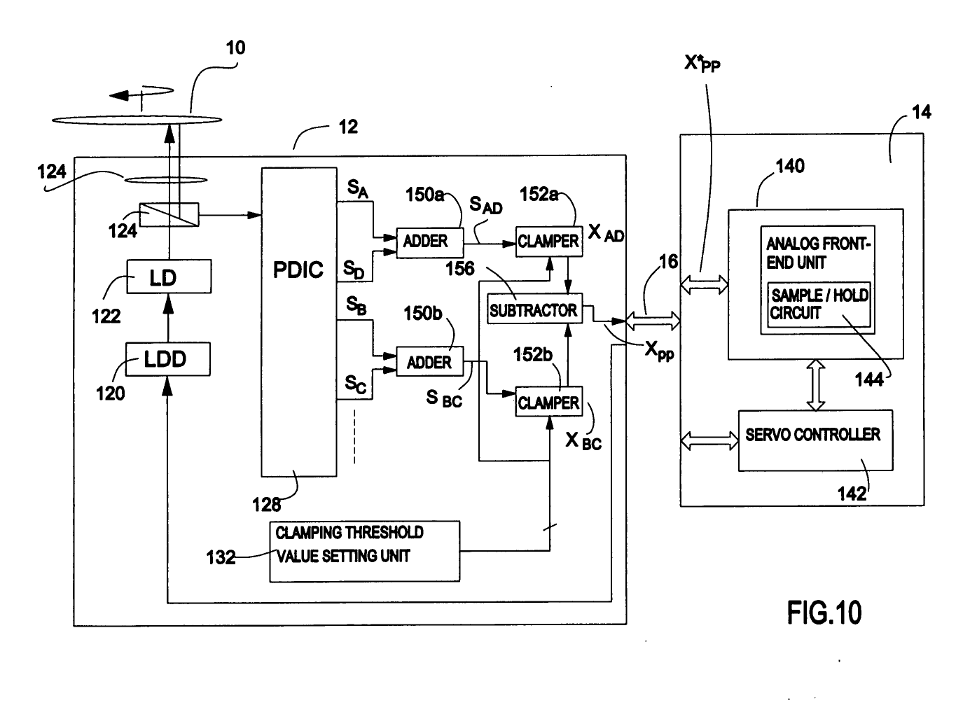

As shown in FIG. 10, this architecture is modified based on the embodiment of FIG. 6. Two adders (150a)(150b) are provided to calculate composite signals S_{AD} and S_{BC}. After the two signals S_{AD} and S_{BC} are processed by the clampers (152a)(152b), the clamped composite signals X_{AD} as well as X_{BC} are subsequently furnished into the subtractor (156) to generate the difference signal X_{PP}, wherein the difference signal is also supplied to the ODD controller (14) through the flexible cable (16).

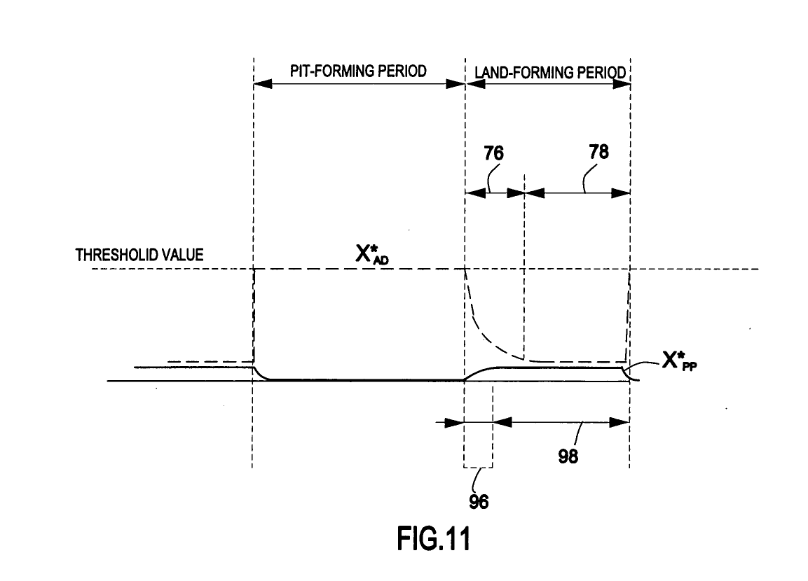

With reference to FIG. 11, after transmitting the difference signal X_{PP} to the ODD controller (14), the received difference signal is designated with X*_{PP}. Since signals X_{AD} and X_{BC} are both limited at the same threshold level during the pit-forming period, their difference signal X_{PP} has a zero level. Therefore, the level of the transmitted signal X*_{PP} during the pit-forming period is also zero. Note that, in practical implementation, an additional bias may be supplied on the difference signal before it is transmitted via the flexible cable (16). During the land-forming period, the difference signal X_{PP} is lower than the threshold value in general. Therefore, for the transmitted signal X*_{PP}, it will still remain at its original level. As shown in the FIG. 11, the level gap of the difference signal X*_{PP} itself between the pit-forming period and the land-forming period is quite small. The level gap is even smaller than that of the signal X*_{AD} between the pit-forming period and the land-forming period, hence the settling time (96) of the clamped difference signal X*_{PP} is much shorter than that (76) of the signal X*_{AD}. The signal X*_{PP} consequently has a longer available time (98) to be sampled that the signal X*_{AD}.

In conclusion, while the optical disk drive is performing data recording process on a CD/DVD, light detection signals or their composite signals are firstly clamped at a preset threshold value before being sent to the ODD controller via the flexible cable. By the signal clamping process, the interference problem, which occurs when the light detections signals are transmitted from the pit-forming period to the land-forming period, is able to be effectively mitigated after these light detection signals or their composite signals are delivered to the ODD controller. In other words, the light detection signals have more available information during the land-forming period to be sampled. Furthermore, superior control signals can be derived to enhance the high speed recording process of the optical disk drive.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An optical disk drive system comprising:
an optical pickup unit that has:
a laser light source generating a laser beam to irradiate a track formed on an optical disk;
a photo detector that receives a reflected light from the optical disk and converts the reflected light into plural light detection signals; and
a clamping unit comprising at least one clamper that clamps at least one electrical signal to derive a clamped signal, whereby the clamped signal keeps below a threshold value; wherein the at least one electrical signal is chosen from either the light detection signals or their composite signals;
an optical disk drive (ODD) controller provided to control the optical pickup unit; and
a flexible cable coupled between the optical disk drive controller and the optical pickup unit for transmitting signals between the optical disk drive controller and the optical pickup unit;
wherein after clamping the at least one electrical signal, the clamped electrical signal is then transmitted to the ODD controller via the flexible cable hence the quality of the received signal by the ODD controller is enhanced.

2. The optical disk drive system as claimed in claim 1, the photo detector comprising four light receiving elements A, B, C and D, wherein two light receiving elements A and D are to receive reflected lights from one side of the track of the optical disk, and the other two light receiving elements B and C are to receive reflected lights from the other side of the track, based on the received reflected lights, the four light receiving elements A-D generate the light detection signals S_{A}, S_{B}, S_{C} and S_{D}, respectively.

3. The optical disk driver system as claimed in claim 2, wherein the at least one electrical signal to be clamped comprises the light detection signals S_{A}, S_{B}, S_{C} and S_{D}, and the clamping unit has four clampers that respectively clamp the four light detection signals S_{A}, S_{B}, S_{C} and S_{D}.

4. The optical disk drive system as claimed in claim 3, the optical pickup unit further comprising:
a first adder coupled between the clamping unit and the flexible cable to perform an addition on the light detection signals S_{A} and S_{D}, wherein an adding result S_{AD} of the first adder is transmitted to the flexible cable; and
a second adder coupled between the clamping unit and the flexible cable to perform an addition on the light detection signals S_{B} and S_{C}, wherein an adding result S_{BC} of the second adder is transmitted to the flexible cable.

5. The optical disk drive system as claimed in claim 3, the optical pickup unit further comprising:
a first adder coupled to the clamping unit to perform an addition on the clamped light detection signals X_{A} and X_{D} thus generating an adding result X_{AD};
a second adder coupled to the clamping unit to perform an addition on the clamped light detection signals X_{B} and X_{C} thus generating an adding result X_{BC}; and
a subtractor coupled among the first adder, the second adder and the flexible cable to perform a subtraction on the two adding results X_{AD} and X_{BC}, wherein a subtraction result of the subtractor is transmitted to the flexible cable.

6. The optical disk drive system as claimed in claim 2, wherein the at least one electrical signal to be clamped comprises the light detection signals S_{A}, S_{B}, S_{C} and S_{D}, and the clamping unit has a first clamper and a second clamper both coupled between the photo detector and the flexible cable;
wherein the optical pickup unit further comprises:
a first adder coupled between the first clamper and the photo detector to perform an addition on the light detection signals S_{A} and S_{D} thus generating a first adding result S_{AD} to be clamped by the first clamper; and
a second adder coupled between the second clamper and the photo detector to perform an addition on the light detection signals S_{B} and S_{C} thus generating a second adding result S_{BC} to be clamped by the second clamper.

7. The optical disk drive system as claimed in claim 2, wherein the at least one electrical signal to be clamped comprises the light detection signals S_{A}, S_{B}, S_{C} and S_{D}, and the clamping unit has a first clamper and a second clamper both coupled to the photo detector;
wherein the optical pickup unit further comprises:
a first adder coupled between the first clamper and the photo detector to perform an addition on the light detection signals S_{A} and S_{D} thus generating a first adding result S_{AD} to be clamped by the first clamper; and
a second adder coupled between the second clamper and the photo detector to perform an addition on the light detection signals S_{B} and S_{C} thus generating a second adding result S_{BC} to be clamped by the second clamper;
a subtractor coupled among the first clamper, the second clamper and the flexible cable to perform a subtraction on the two clamped signals X_{AD} and X_{BC}, wherein a subtraction result of the subtractor is then transmitted to the flexible cable.

8. The optical disk drive system as claimed in claim 2, the optical pickup unit further having a clamping threshold value setting unit to determine the threshold value.

9. An optical pickup device having an output terminal coupled to an optical disk drive controller via a flexible cable, the optical pickup device comprising:
a laser light source generating a laser beam to irradiate a track formed on an optical disk;
a photo detector that receives a reflected light from the optical disk and converts the reflected light into plural light detection signals; and
a clamping unit comprising at least one clamper to clamp at least one electrical signal thereby deriving a clamped signal, whereby the clamped signal keeps below a threshold value; wherein output signals of the clamping unit are coupled to the output terminal of the optical pickup device;
wherein the at least one electrical signal is chosen from either the light detection signals or their composite signals.

10. The optical pickup device as claimed in claim 9, the photo detector comprising four light receiving elements A, B, C and D, wherein two light receiving elements A and D are to receive reflected lights from one side of the track of the optical disk, and the other two light receiving elements B and C are to receive reflected lights from the other side of the track, based on the received reflected lights, the four light receiving elements A-D generate the light detection signals S_{A}, S_{B}, S_{C} and S_{D}, respectively.

11. The optical pickup device as claimed in claim 10, wherein the at least one electrical signal to be clamped comprises the light detection signals S_{A}, S_{B}, S_{C} and S_{D}, and the clamping unit has four clampers that respectively clamp the four light detection signals S_{A}, S_{B}, S_{C} and S_{D}.

12. The optical pickup device as claimed in claim 10, further comprising:
a first adder coupled between the clamping unit and the output terminal of the optical pickup device to perform an addition on the light detection signals S_{A} and S_{D}, wherein an adding result S_{AD} of the first adder is coupled to the output terminal of the optical pickup device; and
a second adder coupled between the clamping unit and the output terminal of the optical pickup device to perform an addition on the light detection signals S_{B} and S_{C}, wherein an adding result S_{BC} of the second adder is coupled to the output terminal of the optical pickup device.

13. The optical pickup device as claimed in claim 11, further comprising:
a first adder coupled to the clamping unit to perform an addition on the clamped light detection signals X_{A} and X_{D} thus generating an adding result X_{AD};
a second adder coupled to the clamping unit to perform an addition on the clamped light detection signals X_{B} and X_{C} thus generating an adding result X_{BC}; and
a subtractor coupled among the first adder, the second adder and the output terminal of the optical pickup device to perform a subtraction on the two adding results X_{AD} and X_{BC}, wherein a subtraction result of the subtractor is transmitted to the output terminal of the optical pickup device.

14. The optical pickup device as claimed in claim 10, wherein the at least one electrical signal to be clamped comprises the light detection signals S_{A}, S_{B}, S_{C} and S_{D}, and the clamping unit has a first clamper and a second clamper both coupled between the photo detector and the output terminal of the optical pickup device;
wherein the optical pickup device further comprises:
a first adder coupled between the first clamper and the photo detector to perform an addition on the light detection signals S_{A} and S_{D} thus generating a first adding result S_{AD} to be clamped by the first clamper; and
a second adder coupled between the second clamper and the photo detector to perform an addition on the light detection signals S_{B} and S_{C} thus generating a second adding result S_{BC} to be clamped by the second clamper.

15. The optical pickup device as claimed in claim 10, wherein the at least one electrical signal to be clamped comprises the light detection signals S_{A}, S_{B}, S_{C} and S_{D}, and the clamping unit has a first clamper and a second clamper both coupled to the photo detector;
the optical pickup device further comprising:
a first adder coupled between the first clamper and the photo detector to perform an addition on the light detection signals S_{A} and S_{D} thus generating a first adding result S_{AD} to be clamped by the first clamper; and
a second adder coupled between the second clamper and the photo detector to perform an addition on the light detection signals S_{B} and S_{C} thus generating a second adding result S_{BC} to be clamped by the second clamper;
a subtractor coupled among the first clamper, the second clamper and the output terminal of the optical pickup device to perform a subtraction on the two clamped signals X_{AD} and X_{BC}, wherein a subtraction result of the subtractor is then coupled to the output terminal of the optical pickup device.

16. The optical pickup device as claimed in claim 9, further having a clamping threshold value setting unit to determine the threshold value.

17. A signal processing method of an optical pickup device for generating at least one output signal, the method comprising the acts of:
receiving a light beam reflected from an optical disk and converting the received light beam into plural light detection signals;
clamping at least one electrical signal so that its level is below a threshold value, wherein the least one electrical signal is chosen from either the light detection signals or their composite signals; and
transmitting output signals of the optical pickup device via a cable to an optical disk drive controller.

18. The method as claimed in claim 17, wherein the light detection signals at least comprise S_{A}, S_{B}, S_{C} and S_{D}.

19. The method as claimed in claim 18, wherein the at least one electrical signal comprises the light detection signals S_{A}, S_{B}, S_{C} and S_{D}, and the output signals of the optical pickup device are the clamped light detection signals.

20. The method as claimed in claim 18, wherein the at least one electrical signal comprises the light detection signals S_{A}, S_{B}, S_{C} and S_{D}, the clamped version of two signals S_{A} and S_{D} are added to form a first composite signal, the clamped version of the other two signals S_{B} and S_{C} are added to form a second composite signal, and the output signals of the optical pickup device are the first composite signal and the second composite signal.

21. The method as clamed in claim 18, the at least one electrical signal comprising the light detection signals S_{A}, S_{B}, S_{C} and S_{D}, wherein the clamped version of two signals S_{A} and S_{D} are added to form a first composite signal, the clamped version of the other two signals S_{B} and S_{C} are added to form a second composite signal, and a subtraction operation is further performed on the first composite signal and the second composite signal to produce a difference signal as the output signal of the optical pickup device.

22. The method as claimed in claim 18, the at least one electrical signal comprising a first electrical signal and a second electrical signal, wherein the first electrical signal is generated by adding the two light detection signals S_{A} and S_{D}, the second electrical signal is generated by adding the other two light detection signals S_{B} and S_{C}, and the clamped first electrical signal and the clamped second electrical signal are the output signals of the optical pickup device.

23. The method as claimed in claim 18, the at least one electrical signal comprising a first electrical signal and a second electrical signal, wherein the first electrical signal is generated by adding the two light detection signals S_{A} and S_{D}, the second electrical signal is generated by adding the other two light detection signals S_{B} and S_{C}, and a subtraction operation is further performed on the clamped first electrical signal and the clamped second electrical signal to produce a difference signal as the output signal of the optical pickup device.
